(19) United States
(12) Patent Application Publication
(10) Pub. No.: US 2007/0056899 A1
(43) Pub. Date: Mar. 15, 2007

(54) HDPE BIAXIALLY ORIENTED NETTING

(75) Inventors: Christopher P. Hakanson, Woodbury, MN (US); Bartley J. Kohel, Oakdale, MN (US); Chris E. Worthington, Saint Paul, MN (US); Andrew J. Thoen, Harris, MN (US)

Correspondence Address: BROOKS KUSHMAN P.C., 1000 TOWN CENTER, TWENTY-SECOND FLOOR, SOUTHFIELD, MI, 48075, US

(73) Assignee: Conwed Plastics LLC, Minneapolis, MN (US)

(21) Appl. No.: 11/531,847

(22) Filed: Sep. 14, 2006

Related U.S. Application Data
(60) Provisional application No. 60/717,514, filed on Sep. 15, 2005.

(51) Int. Cl. B01D 29/085

(52) U.S. Cl. 210/493.5; 442/50; 442/387; 428/175; 428/176; 210/503

(57) ABSTRACT

In at least one embodiment, the present invention provides a biaxially oriented extruded netting. The netting comprises a plurality of interconnected strands with at least some of the strands comprise a HDPE composition comprising a plurality of interconnected strands, with at least some of the strands comprising a composition comprising HDPE. In at least certain embodiments, the net has a strength-to-weight ratio of at least 2.0 lb_{f}/(in.×PMSF). In at least one embodiment, at least 50% of the strands are made of the HDPE composition. The present invention also relates to a method for making biaxially oriented extruded HDPE netting. The method comprises extruding strands of polymer material to form a netting wherein at least some of the strands are formed of the HDPE and biaxially orienting the netting.

### CROSS-REFERENCE TO RELATED APPLICATIONS

This application claims the benefit of U.S. provisional application Serial No. 60/717,514 filed Sep. 15, 2005, which is incorporated herein by reference.

### BACKGROUND OF THE INVENTION

1. Field of the Invention

The present invention relates to HDPE (high density polyethylene) oriented netting, composites made with the HDPE oriented netting, and methods for making the same. The orientation of the netting can be either biaxially or in the cross-direction only.

2. Background Art

The continuous extrusion of plastic netting started in the 1950's. Extruded netting is netting in which the strands are extruded from a die, the joints therebetween being formed either within the die or immediately outside the die. A variety of configurations are known, such as square, diamond, twill, etc. Some of the more common materials used to prepare extruded netting are polypropylene, polyethylene (particularly linear low grades, and ethylene copolymers), nylon, polybutylene, and blends thereof.

Currently, the extrusion process of choice for manufacturing plastic nets is one in which individual plastic strands are extruded in an interconnecting network to provide the net-like structure. Typically, either a rotary or a reciprocating extrusion process is employed. Methods for practicing the reciprocating technique are well known. For instance, U.S. Pat. No. 3,700,521; U.S. Pat. No. 3,767,353; U.S. Pat. No. 3,723,218; U.S. Pat. No. 4,123,491; U.S. Pat. No. 4,152,479 and U.S. Pat. No. 4,190,692 show apparatus and method for making nets by the continuous extrusion of individual plastic strands. The disclosures of the above-mentioned issued patents are incorporated by reference into the present application.

In certain, relatively common, extruded netting manufacturing processes, plastic netting is typically extruded though an annular die and quenched in a water tank. The extrusion typically takes a tubular form. The resulting tubular netting is collapsed in a quench tank, slit, and opened up to a flat sheet. The flat sheet is then wound onto rolls. This flat sheet netting is defined as “Stage 1 netting,” i.e., extruded but not oriented netting.

After being wound, the flat sheet can undergo a biaxial orientation process where it is expanded, or stretched, in two directions—the machine direction (MD) and the cross-machine or transverse direction (TD). This biaxially oriented sheet netting is defined as “Stage 2 netting.” Alternatively, the flat sheet can undergo a TD orientation only.

These types of plastic netting have found a number of uses in commerce. For example, these nets have found use as erosion control netting, breathable packaging netting for produce and other perishable items, agricultural netting, such as turf netting, turf wrap, hay bale wrap and netting for industrial, filtration and home furnishings applications.

Netting has also found use in certain composites. In such composites the netting is laminated or otherwise combined with one or more fabric overlays. Chief among such uses and composites are fabrics for disposable diapers, incontinent briefs, training pants, bandages, dressings, diaper holders and liners, feminine hygiene garments, medical gowns, medical drapes, mattress pads, blankets, sheets, clothing, consumer wipes and other like products, such as building and construction composites.

To take advantage of the relatively strong physical properties of HDPE, HDPE has been explored as a material for making extruded netting. While extruded HDPE nets have certain desired physical properties, such as relatively high tensile strength, compatibility with polyethylene substrates, relatively low stiffness, and flexibility at low temperatures, oriented HDPE netting has been less widely available than extruded HDPE netting. The primary reason for this has been the difficulty to biaxially orient (and cross-direction orient) extruded HDPE netting, especially for square-shaped nets made via the reciprocating extrusion process. As set forth above, biaxial orientation is generally the process of stretching the extruded net in two directions (i.e., the machine and transverse directions) to reduce the strand thickness while at the same time increasing the strength to weight ratio of the netting. Cross-direction orientation is the process of orienting a netting in the TD.

One advantage of oriented square net (made via reciprocating extrusion process) verses oriented bias cut diamond (made via the rotary extrusion process) is the relative smoothness of one side of the netting, which can result in less damage/abrasion when combining netting with substrates and other materials. Also, oriented square netting can be produced in relatively wide widths.

As such, the material used to make the square netting must be able to be both extruded via the reciprocating extrusion process and biaxially (or at least TD) oriented to form netting having desired structural properties, such as flexibility, tensile strength and cost effectiveness.

### SUMMARY OF THE INVENTION

In at least one embodiment, the present invention provides a biaxially oriented HDPE reciprocated extruded netting. The netting comprises a plurality of interconnected strands. In at least one embodiment, the strands comprise a HDPE that can be reciprocated extruded and later biaxially oriented in accordance with customary biaxial orienting procedures without breaking. In at least another embodiment, at least one-half of the strands comprise HDPE that can be extruded via the reciprocating extrusion process and later biaxially oriented in accordance with customary biaxal orienting procedures without breaking. In at least one embodiment, the biaxially oriented HDPE netting has a strength-to-weight ratio of at least 2.0 lb_{f}/(in.×PMSF). In at least one embodiment, the biaxially oriented HDPE netting will have a tensile strength of at least 1.0 lb./in. In at least one embodiment, the extruded netting will only be oriented in the cross-direction.

In at least one embodiment, at least 75% of the strands are made of the HDPE.

In at least one embodiment, at least 90% of the strands are made of the HDPE.

In at least another embodiment, essentially 100% of the strands are made of the HDPE.

In at least one embodiment, the HDPE comprises a homopolymer. In at least another embodiment, the HDPE comprises a copolymer.

In at least one embodiment, the HDPE has an average molecular weight (Mn) of 12,000-20,000, a weighted average molecular weight (Mw) of 90,000-130,000, a number average molecular weight (Mz) of 325,000-550,000, a peak average molecular weight (Mp) of 25,000-60,000, and a polydispersity index [(PDI) (Mw/Mn)] of 5.00-8.50.

In at least one embodiment, the HDPE has an average molecular weight (Mn) of 12,500-17,000, a weighted average molecular weight (Mw) of 92,000-100,000, a number average molecular weight (Mz) of 330,000-450,000, a peak average molecular weight (Mp) of 27,500-40,000, and a polydispersity index [(PDI) (Mw/Mn)] of 6.00-7.25.

In at least one embodiment, the HDPE has an average molecular weight (Mn) of 13,000-13,850, a weighted average molecular weight (Mw) of 93,000-95,500, a number average molecular weight (Mz) of 345,000-400,000, a peak average molecular weight (Mp) of 30,000-36,000, and a polydispersity index [(PDI) (Mw/Mn)] of 6.75-7.25.

In at least one embodiment, the HDPE has an average molecular weight (Mn) of 13,200-13,800, a weighted average molecular weight (Mw) of 94,000-95,000, a number average molecular weight (Mz) of 365,000-390,000, a peak average molecular weight (Mp) of 32,500-34,500, and a polydispersity index [(PDI) (Mw/Mn)] of 6.80-7.10.

In at least one embodiment, the HDPE has an average molecular weight (Mn) of 13,641, a weighted average molecular weight (Mw) of 94,543, a number average molecular weight (Mz) of 382,614, a peak average molecular weight (Mp) of 33,632, and a polydispersity index [(PDI) (Mw/Mn)] of 6.93.

In at least one embodiment, the HDPE has a melt flow index of 0.3-2.0 g/10 min. and a density of 0.940-0.965 g/cc. In at least another embodiment, the HDPE has a melt flow index of 0.75-1.25 g/10 min. and a density of 0.956-0.959 g/cc.

In at least one embodiment, the HDPE has a melt flow index of 0.85-1.05 g/10 min. and a density of 0.958 g/cc.

In at least one embodiment, the biaxially oriented HDPE netting has an average strand thickness of 1-300 mils.

In at least one embodiment, the biaxially oriented HDPE netting has a tensile strength of 1-50 lb./in.

In at least certain embodiments, the HDPE has an average molecular weight (Mn) of 5,000 to 20,000, in certain other embodiments of 6,250 to 17,000, in yet certain other embodiments of 7,500 to 13,850, and in still yet certain other embodiments of 8,500 to 13,750. In at least certain embodiments, the HDPE has a peak average molecular weight (Mp) of 18,000 to 60,000, in certain other embodiments of 19,500 to 40,000, in yet certain other embodiments of 21,500 to 36,000, and in still yet certain other embodiments of 22,000 to 34,500. In at least certain embodiments, the HDPE has a polydispersity index [(PDI) (Mw/Mn)] of 5.0 to 14, in certain other embodiments of 5.0 to 13.50, in yet certain other embodiments of 6.75 to 13.25, and in still yet certain other embodiments of 6.8 to 13.0.

In at least another embodiment, the present invention also relates to a method for making biaxially oriented extruded HDPE netting. The method comprises reciprocating extruding strands of HDPE to form a netting with at least a portion of the strands comprising HDPE and biaxially orienting the extruded netting.

In at least another embodiment, the present invention also relates to a method for making cross-direction oriented extruded HDPE netting. The method comprises reciprocating extruding strands of HDPE to form a netting with at least a portion of the strands comprising HDPE and cross-directionally orienting the extruded netting.

In at least one embodiment, the strands are extruded to have a square or rectangular net configuration.

### BRIEF DESCRIPTION OF THE DRAWINGS

FIG. 1 is perspective view of an embodiment of the netting of the present invention;

FIG. 2 is an illustration of a test sample;

FIG. 3 is an illustration of a sample stress strain curve; and

FIG. 4 is a schematic illustration of a filter made in accordance with the present invention.

### DETAILED DESCRIPTION OF THE PREFERRED EMBODIMENTS

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

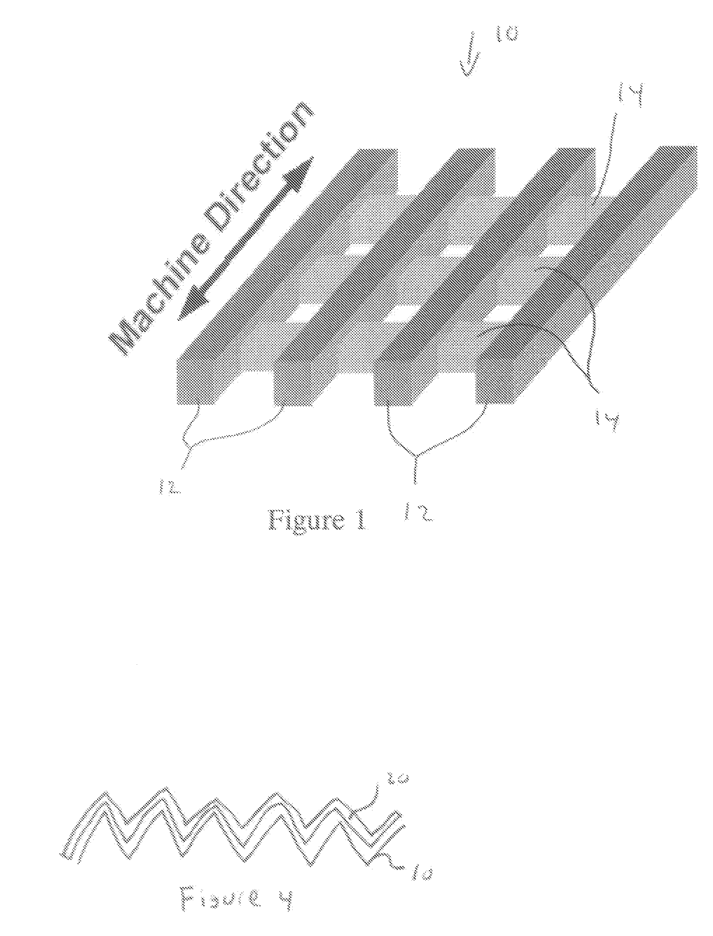

The present invention provides a netting 10 as shown in FIG. 1. The netting comprises strands 12 extending in one direction and strands 14 extending in a generally crosswise or transverse direction. The strands are extruded polymeric elongate members which cross and intersect during extrusion to form the net-like structure. In at least one embodiment, the strands 12 and 14 are made of the same material. In other words, 100% of the strands are made of the same material.

In at least another embodiment, strands 12 are made of a different material than strands 14. In this embodiment, the netting may comprise 10 to 90 wt. % of the material comprising strands 12 and 90 to 10 wt. % of the material comprising strands 14. In other embodiments, the netting may comprise 35 to 65 wt. % of the material comprising strands 12 and 65 to 35 wt. % of the material comprising strands 14. In yet other embodiments, the netting may comprise 45 to 55 wt. % of the material comprising strands 12 and 55 to 45 wt. % of the material comprising strands 14.

In embodiments where the strands 12 and 14 are made of the same material, the material comprising the strands 12 and 14 is a HDPE material. When a material other then the HDPE material is used to manufacture one of the sets of strands 12 or 14, such material may comprise another suitable extrudable material. For instance, some of the strands, such as 12, may comprise the HDPE material, while the other strands, such as 14, may comprise a different material than the HDPE material. Any such suitable other material could be used such as elastomeric materials such as styrenic block copolymers, Hytrel®, and Santoprene® and polyurethane, polyester, and polyamide thermoplastic elastomers. Other suitable material may also comprise non-elastomeric materials such as nylons, polyesters, polypropylene, lower density polyethylenes and copolymers of such resins, with the polyolefins being preferred and with polypropylene being especially preferred.

In at least one embodiment, the HDPE suitable for use with the invention is HDPE that can result in a structurally sound reciprocated extruded and biaxially (or cross-direction only) oriented netting. By structurally sound reciprocated extruded and biaxially oriented netting, it is meant netting that is made by first reciprocating extrusion and that can later be biaxailly oriented without failing, i.e., breaking. Successful orientation without failing means there is minimal variation in the strand spacing of the oriented netting, as large variations in stand spacing indicate areas of the netting have significantly different amounts of orientation. Areas with less orientation will have thicker, weaker strands than areas that are fully oriented. Previous to the present invention, HDPE could not be extruded using the square/reciprocating process and then be fully oriented. Strands would begin breaking when many areas of the netting were still not fully oriented. In at least certain embodiments, the HDPE is capable of being reciprocated extruded into square or rectangular intersection netting and later biaxially (or cross-direction) oriented without failing.

The extent of orientation of the netting strands can be characterized by an orientation ratio, which is the ratio of the length of the strand after orientation to the length of the strand before orientation. For HDPE netting made by the reciprocating process, full orientation of the strands results in an orientation ratio of between 2.5 and 10.0, in other embodiments, 2.75-8.0 and in yet other embodiments 3.0-6.0. Prior to the invention, reciprocating process HDPE netting could only be oriented at orientation ratios below 2.5.

The suitability of a particular grade of HDPE for biaxial or cross-direction orientation in a reciprocating net extrusion process can be analyzed by tensile properties of film test shapes made from the HDPE. The HDPE can be extruded into a film or sheet, then cut into standardized shapes. These shapes can then be tested in a tensile tester under a range of temperatures, with jaw gap and crosshead speed remaining constant. The resulting stress data can be used to evaluate the orientability of the HDPE.

Cast film can be prepared in a number of ways. One way is to use a 1″ laboratory extruder equipped with a sheet die with a gap of 0.040″ and chill rollers. Maintaining similar run conditions (temperatures, line speeds, etc.) and film thickness of around 0.015″ with each HPDE tested reduces the impact of variation in melt orientation on the tensile properties of the test samples.

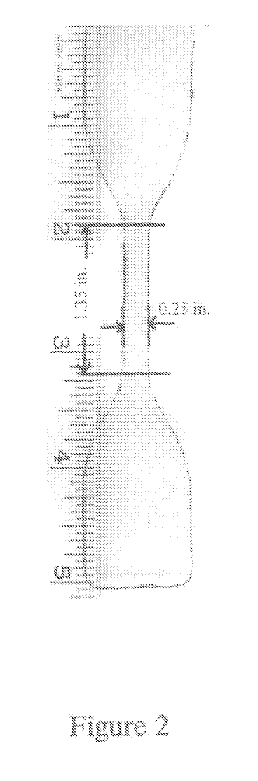

The cast film can be cut into a standard shape, for instance such as using a dogbone-shaped cutter, yielding the sample illustrated in FIG. 2. The thickness of the sample is measured before testing, and the cross sectional area of the narrowest portion of the sample determined. Tensile tester jaw gap can be set to correspond with the length of the narrowest portion of the sample. In the illustration shown in FIG. 2 this results in a jaw gap of 1.35″.

The sample is tested at room temperature at a crosshead speed of 12″ per minute, and at elevated temperatures at a crosshead speed of 40″ per minute.

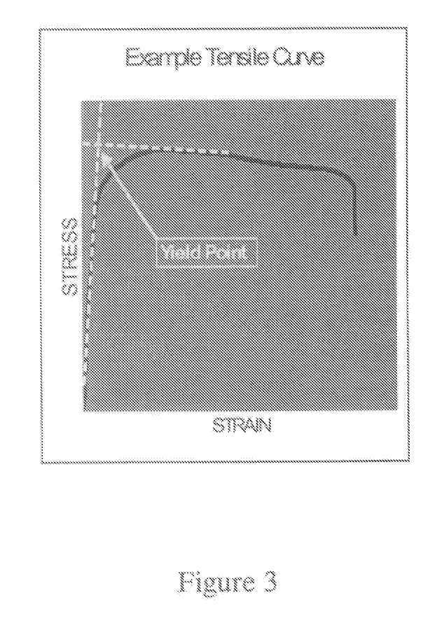

Stress vs. strain curves can be generated for HDPE resin. Yield stress can be determined using the tangent method, where the yield point is taken as the intersection of lines drawn parallel to both portions of the stress vs. strain curve; the initial, steep portion and the later, relatively flat portion (FIG. 3). Peak stress can be determined from the greatest stress value observed in the tensile test.

In at least one embodiment, the relationship between yield stress and peak stress can be an indicator of the suitability of a particular grade of HDPE for extrusion and subsequent orientation of netting made by the reciprocating process. Using the procedure outlined here, in at least one embodiment, it has been found that for effective orientation, a HDPE resin will demonstrate a peak stress:yield stress ratio of at least 1.3, and in other embodiments between 1.3-2.8, and in yet other embodiments between 1.5-2.6.

The peak stress vs. yield stress ratio for a given resin does vary with temperature. For HDPE, an appropriate range for evaluation is between 200° F. and 240° F. Typically grades of HDPE that have a minimum peak stress:yield stress ratio of greater than 1.3 at some temperature can produce orientable reciprocating process net.

In at least one embodiment, the HDPE has an average molecular weight (Mn) of between 12,000 and 20,000. In other embodiments, the average molecular weight is between 12,500 and 17,000, in yet other embodiments between 13,000 and 13,850, and in still yet other embodiments between 13,200 and 13,800, and in still yet even other embodiments between 13,500 and 13,700.

In at least one embodiment, the HDPE has a weight average molecular weight (Mw) of between 90,000 and 130,000, in another embodiment of 92,000 and 100,000, and in yet another embodiment of 93,000 and 95,500. In still yet other embodiments, the weight average molecular weight is between 94,000 and 95,000, and in still yet further other embodiments between 94,125 and 94,725.

In at least one embodiment, the HDPE has a number average molecular weight (Mz) of between 325,000 and 550,000. In other embodiments, the number average molecular weight is between 330,000 and 450,000, in yet other embodiments between 345,000 and 400,000, in still yet other embodiments between 365,000 and 390,000, and in yet still even other embodiments between 375,000 and 386,000.

In at least one embodiment, the HDPE has a peak average molecular weight (Mp) of between 25,000 and 60,000. In other embodiments, the peak average molecular weight is between 27,500 and 40,000, in yet other embodiments between 30,000 and 36,000, in still yet other embodiments between 32,500 and 34,500, and in still yet even other embodiments between 33,000 and 34,000.

The polydispersity index (PDI) of the HDPE is generally a function of branching or crosslinking and is a measure of the breadth of the molecular weight distribution. In certain embodiments the PDI (Mw/Mn) of the HDPE is between 5.0 and 8.5, in other embodiments between 6.0 and 8.0, in yet other embodiments between 6.0 and 7.25, in still yet other embodiments between 6.80 and 7.10, and in still yet even other embodiments between 6.90 and 7.0.

Furthermore, the melt flow rate (MFR) of the HDPE can be measured using ASTM: D 1238. In certain embodiments the polymer has a melt flow rate between 0.3 and 2.0 g/10 min., in yet other embodiments between 0.75 and 1.25 g/10 min., in still yet other embodiments between 0.85 and 1.05 g/10 min., and in still yet even other embodiments between 0.9 and 1.0 g/10 min.

The density of the HDPE can be measured by ASTM D792. In certain embodiments the polymer has a density of between 0.940 and 0.965 g/cc, in other embodiments between 0.956 and 0.959 g/cc, in yet other embodiments between 0.957 and 0.958 g/cc, and in still yet other embodiments of 0.958 g/cc.

Suitable HDPE include, Alathon® M6210 from Equistar. In certain embodiments, HDPE may have the following characteristics:

Avg. Mw=94,543+/−900

Avg. Mn=13,641+/−200

PDI=Mw/Mn=6.93+/−0.15

Density=0.958 g/cc

In at least one embodiment, the HDPE suitable for use with the present invention result in a biaxially extruded netting having a tensile strength of at least 1.0 lb./in. as measured by ASTM No. D5035.

In still yet other embodiments, the HDPE suitable for use with the present invention results in a biaxially oriented netting having a strength-to-weight ratio of 2.0 to 10 lb_{f}/(in.×PMSF), in at least another embodiment of 3 to 6 lb_{f}/(in. ×PMSF) and in yet another embodiment of 4 to 5 lb_{f}/(in.×PMSF). In certain embodiments, CD-only oriented netting can have a strength-to-weight ratio of less than 2.0.

Strength to weight ratio can be determined by the following equation:
Strength-to-weight=(tensile strength in machine direction+tensile strength in cross-machine directions)/basis weight.

Basis weight can be determined in accordance with ASTM No. D3776.

Tensile strength of the netting can be determined by the netting tensile strength tests.

The netting tensile strength test for Stage 2 netting can be determined by a modified ASTM D5035 as follows:

Cut four 3″×8″ specimens in each direction (MD and CD), evenly spaced from the sample to be tested. Use a constant-rate-of-extension tensile tester, such as the Instron 5500R tensile tester. The tensile tester's crosshead gap is three inches. Insert the specimen tightly into the crosshead jaws, and use a 12 in./min crosshead speed. Record the peak force observed at or before the point when the specimen breaks. Calculate the average of the result of the four tests, and normalize the average peak tensile force to tensile strength per inch by multiplying the average peak tensile force by the ratio: [exact measured or calculated number of strands in the test direction per inch]/[tested number of strands].

In certain embodiments, the HDPE of the present invention, i.e., that result in oriented netting having a strength-to-weight ratio above 2.0 lb_{f}/(in.×PMSF), can be blended with other HDPE (having lower strength-to-weight ratio) and/or with other elastomeric and non-elastomeric materials mentioned above. In these embodiments, the blend can result in netting having a strength-to-weight ratio above or below 2.0 lb_{f}/(in.×PMSF). Suitable blends could include 90 wt. % HDPE of the present invention and 10% of non-HDPE of the present invention, in other embodiments 20-80 wt. % of HDPE of the present invention and 80-20 wt. % non-HDPE of the present invention, and in yet other embodiments 40-60wt. % HDPE of the present invention and 60-40 wt. % of non-HDPE of the present invention.

Whether alone or blended with another resin, the HDPE composition may include suitable additives, as are known in the art. Examples of suitable additives include, but are not necessarily limited to, colorant, heat stabilizers, UV light stabilizers and UV light degraders/degradation accelerators.

In at least one embodiment, the biaxially oriented extruded netting can be made by any suitable reciprocating netting extrusion process and then later biaxially oriented by any suitable biaxial orienting processes. Suitable examples of these processes are set forth in the Background of the Invention, herein. Generally, suitable methods for making the netting comprises extruding the HDPE or the HDPE composition (hereafter the HDPE composition will be used to refer to either) through dies with reciprocating parts to form the netting configuration. This creates cross machine direction strands that cross the machine direction strands, which flow continuously. After the extrusion, the netting is then typically stretched in the machine direction using a speed differential between two sets of nip rollers. After this, the material is then typically stretched in the cross direction using a tentor frame. It should be understood, that the above described method is just one of many suitable methods that can be employed to manufacture reciprocating extruded biaxially oriented HDPE netting in accordance with the present invention. Alternatively, instead of biaxially orienting, the netting could only be oriented in the cross- or transverse-direction (TD). Also, while the principles of this invention can apply to any net geometry, the present invention has excellent applicability to square netting. Of course, it should be understood that the HDPE composition could be used to form both the cross machine direction strands and the machine direction strands, or one or part of the strands, in which case, another material such as PP (polypropylene) or an elastomeric material such as Kraton®, could be used to form the other strands.

In at least one embodiment, the Stage 1 netting will have a strength-to-weight ratio of 0.5 to 1.5 lb_{f}/(in.×PMSF), in other embodiments 0.8 to 1.15 lb_{f}/(in.×PMSF), and in yet other embodiments 0.9 to 1.1 lb_{f}/(in.×PMSF).

In at least one embodiment, the Stage 2 netting will have a strength-to-weight ratio of 2.0 to 10 lb_{f}/(in.×PMSF), in other embodiments 3 to 6 lb_{f}/(in. ×PMSF), and in yet other embodiments 4 to 5 lb_{f}/(in.×PMSF).

In at least one embodiment, the biaxially oriented HDPE netting has a basis weight of between 0.3 to 150 lbs./1000 square feet, in other embodiments between 1 to 50 lbs./1000 square feet, and in yet other embodiments 1 to 25 lbs./1000 square feet, as measured in accordance with ASTM: D 3776.

In at least one embodiment, the biaxially oriented HDPE netting has a machine direction peak strength of 0.5 to 100 lbs./strand, in other embodiments between 1 to 25 lbs. /strand, and in yet other embodiments 2 to 15 lbs./strand.

In at least one embodiment, the biaxially oriented HDPE netting has a cross direction peak strength of 0.5 to 100 lbs./strand, in other embodiments between 1 to 25 lbs./strand, and in yet other embodiments 2 to 15 lbs./strand.

In at least one embodiment, the biaxially oriented HDPE netting has a machine direction strands per inch (i.e., strand count) of 0.1 to 50 strands/inch, in other embodiments 0.5 to 25 strands per inch, and in yet other embodiments 1 to 10 strands/inch.

In at least one embodiment, the biaxially oriented HDPE netting has a cross direction strands per inch of 0.1 to 50 strands/inch, in other embodiments 0.5 to 25 strands/inch, and in yet other embodiments 1 to 6 strands per inch.

In some embodiments, the biaxially oriented HDPE netting has strands that have an average thickness (i.e., diameter) of 0.5 to 50 mils, in other embodiments 0.75 to 15 mils, and in yet other embodiments 1 to 10 mils.

In some embodiments, the biaxially oriented HDPE netting has joints that have an average thickness (i.e., diameter) of 1 to 300 mils, in other embodiments 5 to 75 mils, and in yet other embodiments 10 to 50 mils.

In certain embodiments, the netting will have one side that is generally flat.

The netting made in accordance with the present invention has many potential uses. Particularly, the properties of the netting make the netting of the invention particularly suitable for use as support or backing in filtration applications, including pleating at ambient temperatures and other composite manufacturing methods, including extrusion coating, lamination, and others, where a relatively flat side of netting is desired.

In composites wherein the netting is secured to at least one or more layers of material. Examples of such composites include roof underlayments, building wraps, and other construction materials, consumer wipes, reinforced tissue towels, and erosion control composites. Other examples include 3-D structures where HDPE can be formed into the structures at ambient or slightly elevated temperatures (substantially ambient), such as erosion control structures and filter media pleat support. A schematic filter is shown in FIG. 4 where a netting 10 made in accordance with the present invention has been pleated and a filter media 20 is supported by the pleated netting. The pleated netting 10 illustrated in FIG. 4 has been pleated at substantially ambient temperatures.

The present invention may be further appreciated by consideration of the following, non-limiting examples, and certain benefits of the present invention may be further appreciated by the examples set forth below.

### EXAMPLES

### Example 1

An extruded netting is produced at a basis weight of 45 lbs./1000 sq. ft. and a total width 47 inches. The raw material composition is 100.0% Alathon® M6210 from Equistar. The extruded netting has a machine direction strand count of 21.5 strands per inch, and a cross direction strand count of 17.5 strands per inch. The extruded netting's machine direction (MD) peak strength is 1.2 lbs./strand, and its cross-direction (CD) peak strength is 1.0 lbs./strand.

The molecular weight of the HDPE was characterized using gel permeation chromatography (GPC). The GPC analysis was done using the following equipment and conditions:
Waters Styragel colums (4 in series)
Temperature=135° C.
Eluent/mobile phase: 1,2,4-Trichlorobenzene
Stabilizer: Santanox R@0.2%
Standards: 3 n-Alkanes (283-843)+4 narrow polyethylenes
Sample prep: 12 mg in 4 mL

This analysis yielded the following information on the HDPE M6210:

| | |
|---|---|
| Average molecular weight (Mn) | 13,641 |
| Weighted average molecular weight (Mw) | 94,543 |
| Number average molecular weight (Mz) | 382,614 |
| Peak average molecular weight (Mp) | 33,632 |
| Polydispersity index (Mw/Mn) | 6.93 |

The extruded netting is subsequently biaxially oriented by first stretching the extruded netting in the machine direction at a temperature of around 230° F. with an orientation ratio of 3.60. The netting is then immediately stretched in the cross-direction at a temperature of around 230° F. with an orientation ratio of 4.69. The resulting biaxially oriented netting has 4.5 strands per inch in the MD and 5.0 strands per inch in the CD. The average MD peak strength is 1.60 lbs./strand, and the average CD peak strength is 1.20 lbs./strand.

### Example 2

An extruded netting is produced at a basis weight of 42 lbs./1000 sq. ft. and a total width of 50″ inches. The raw material composition is 97.5% 35060E from Dow Plastics, 1.5% UV stabilizer and 1.0% process aid. The extruded netting has a machine direction strand count of 19 strands per inch, and a cross direction stand count of 15 stands per inch. The extruded netting's machine direction (MD) peak strength is 1.16 lbs/strand, and its cross direction (CD) peak strength is 0.80 lbs/strand.

The extruded netting is subsequently biaxially oriented by first stretching the extruded netting in the machine direction at a temperature of around 240° F., with an orientation ratio of 2.94. The netting is then immediately stretched in the cross direction at a temperature of around 240° F., with an orientation ratio of 4.11. The resulting biaxially oriented netting has 4.6 strands per inch in the MD and 5.1 strands per inch in the CD. The average MD peak strength is 1.2 lbs/strand, and the average CD peak strength is 1.09 lbs/strand.

### Example 3

An extruded netting is produced at a basis weight of 34.5 lbs./1000 sq. ft. and a total width 37.5″ inches. The raw material composition is 66.5% Alathon® M6210 from Equistar, 33% Alathon® M6030B from Equistar, and 0.5% black colorant 24000 from Standridge Color Corporation. The extruded netting has a machine direction strand count of 17.5 strands per inch, and a cross direction strand count of 16.0 strands per inch. The extruded netting's machine direction (MD) peak strength is 0.88 lbs/strand, and its cross direction (CD) peak strength is 0.59 lbs/strand.

Alathon® M6030B from Equistar is an HDPE resin with the following properties:

| | |
|---|---|
| Melt index | 3.00 |
| Density | 0.960 |
| Average molecular weight (Mn) | 16,418 |
| Weighted average molecular weight (Mw) | 93,221 |
| Number average molecular weight (Mz) | 345,018 |
| Peak average molecular weight (Mp) | 30,704 |
| Polydispersity index (Mw/Mn) | 5.68 |

The extruded netting is subsequently biaxially oriented by first stretching the extruded netting in the machine direction at a temperature of around 230° F., with an orientation ratio of 3.90. The netting is then immediately stretched in the cross direction at a temperature of around 235° F., with an orientation ratio of 4.44. The resulting biaxially oriented netting had 4.0 strands per inch in the MD and 4.0 strands per inch in the CD. The average MD breaking load is 1.08 lbs/strand, and the average CD breaking load is 1.05 lbs/strand.

### Example 4

An extruded netting is produced at a basis weight of 41.5 lbs./1000 sq. ft. and a total width of 39″ inches. The raw material composition is 25 % 7194 HDPE from Fina and 75% Alathon® M6210 from Equistar. The extruded netting has a machine direction strand count of 9.5 strands per inch, and a cross direction strand count of 2 strands per inch. The extruded netting's machine direction (MD) peak strength is 4.5 lbs/strand, and its cross direction (CD) peak strength is 4.2 lbs/strand.

The extruded netting is subsequently oriented only in the cross direction by stretching the extruded netting in the cross direction at a temperature of around 240° F., with an orientation ratio of 4.60. The resulting cross direction oriented netting has 2 strands per inch in the MD and 2 strands per inch in the CD. The average MD peak strength is 3 lbs/strand, and the average CD peak strength is 5.4 lbs/strand.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A biaxially oriented extruded netting, said netting comprising a plurality of interconnected strands, at least some of the strands comprise a composition comprising HDPE, capable of providing a biaxially extruded netting having a strength-to-weight ratio of at least 2.0 lb_{f}/(in.×PMSF).

2. The netting of claim 1 wherein at least 50% of the strands are made of the biodegradable composition.

3. The netting of claim 1 wherein essentially 100% of the strands are made of the biodegradable composition.

4. The netting of claim 1 wherein the composition comprises 5 to 95 weight percent of the HDPE and 95 to 5 weight percent of the different polymeric material.

5. The netting of claim 1 wherein the composition comprises 40 to 60 weight percent of the HDPE and 60 to 40 weight percent of the different polymeric material.

6. The netting of claim 1 wherein the composition comprises 100% of the HDPE.

7. The netting of claim 5 wherein the HDPE has an average molecular weight (Mn) of 13,000-13,850, a weighted average molecular weight (Mw) of 93,500-95,500, a number average molecular weight (Mz) of 345,000-400,000, a peak average molecular weight (Mp) of 30,000-36,000, and a polydispersity index [(PDI) (Mw/Mn)] of 6.75-7.25.

8. The netting of claim 5 wherein the HDPE has a melt flow index of 0.75-1.25 g/10 min. and a density of 0.956-0.959 g/cc.

9. The netting of claim 1 wherein the netting has a square-shaped configuration.

10. A method of making a biaxially oriented HDPE extruded netting, said method comprising interconnecting a plurality of strands wherein at least some of the strands comprise a composition comprising HDPE, the netting having a strength-to-weight ratio of at least 2.0 lb_{f}/(in.×PMSF).

11. The method of claim 10 wherein the step of interconnecting comprises extruding a first set of stands in a first direction and extruding a second set of strands in a second direction so that the second set of strands intersect the first set of strands.

12. The method of claim 11 wherein the netting has a square configuration.

13. A composite, said composite comprising:
the netting of claim 1, the netting having a first side and a second side, opposite the first side; and
a first layer of material secured to the first side of the netting.

14. The composite of claim 13 further comprising a second layer of material secured to the second side of the netting.

15. The composite of claim 13 wherein the netting is hydroentangled or needle punched into the layer (or more than one layer).

16. The composite of claim 13 wherein the netting has a pleated configuration and the first layer of material is a filter media.

17. A cold pleated filter comprising:
an oriented extruded netting comprising a plurality of interconnected strands, at least some of the strands comprise a composition comprising HDPE, capable of providing a biaxially extruded netting having a strength-to-weight ratio of at least 2.0 lb_{f}/(in.×PMSF), the netting having a pleated configuration; and
a filter media supported by the netting.

18. The filter of claim 17 wherein the pleated configuration was formed at substantially ambient temperature.

19. A method of making a pleated filter, said method comprising:
providing the netting of claim 1;
forming pleats in the netting at substantially ambient temperatures; and
supporting a filter media on the pleated netting.

20. The method of claim 19 wherein the filter media is secured to the pleated netting.
